(19) United States
(12) Patent Application Publication
(10) Pub. No.: US 2026/0109364 A1
(43) Pub. Date: Apr. 23, 2026

(54) ARITHMETIC DEVICE AND VEHICLE CONTROL DEVICE

(71) Applicant: MITSUBISHI JIDOSHA KOGYO KABUSHIKI KAISHA, Tokyo (JP)

(72) Inventors: Hiroo ABE, Tokyo (JP); Ryo HACHISUKA, Tokyo (JP); Shunsuke MATSUO, Tokyo (JP)

(73) Assignee: MITSUBISHI JIDOSHA KOGYO KABUSHIKI KAISHA, Tokyo (JP)

(21) Appl. No.: 18/860,275

(22) PCT Filed: Apr. 21, 2023
(86) PCT No.: PCT/JP2023/015966

§ 371 Date: Jun. 18, 2025

(30) Foreign Application Priority Data
Apr. 28, 2022 (JP) 2022-074226

(51) Int. Cl. B60W 50/06; B60W 40/13

(52) U.S. Cl. CPC B60W 50/06; B60W 40/13; B60W 2520/105; B60W 2520/125; B60W 2520/14; B60W 2520/18

(57) ABSTRACT

An arithmetic device that obtains a minimizing solution, which minimizes a predetermined evaluation function while satisfying a predetermined constraint, includes a first arithmetic operator that sets at least one point on a boundary of the evaluation function obtained from the constraint as at least one of solution candidates and determines a solution that minimizes the evaluation function from among the solution candidates as a provisional solution, and a second arithmetic operator that calculates a solution that gives an extreme value of the evaluation function from a predetermined expression and specifies the minimizing solution based on the solution that gives the extreme value and the provisional solution. The arithmetic device obtains the minimizing solution without performing iterative calculation. A control device (10) including an arithmetic device operator (12) serving as the arithmetic device, calculates braking and driving forces of respective wheels (2) using a minimizing solution obtained on the basis of a total braking and driving force of a vehicle (1), a total difference between left and right braking and driving forces, and lateral forces and vertical loads of the respective wheels (2). The constraint includes, for each of front and rear actuators (3-7), not exceeding a maximum difference between left and right torques and a maximum torque.

### TECHNICAL FIELD

The embodiment discussed herein relates to an arithmetic device for solving a constrained minimization problem without iterative calculation, and a vehicle control device using the arithmetic device.

### BACKGROUND TECHNIQUE

For example, vehicle motion control desires constant grasping of the driving force and the braking force (hereinafter, collectively referred to as “braking and driving force”) of each wheel and applying of an appropriate control amount (e.g., driving force, braking force) to each wheel in accordance with the traveling road and the driver demand. In order to grasp the vehicle condition as well as the braking and driving force, detected values by on-board sensors are used. However, since all data cannot be detected by the sensors, a method of calculation (estimation) using a predetermined condition or a numerical expression (function) is adopted. An example of the method of calculation is a method of solving a minimization problem of a predetermined function by iterative calculation within a range satisfying a predetermined constraint (see, for example, Patent Documents 1 and 2). By solving the minimization problem, an appropriate control amount corresponding to, for example, the vehicle condition can be obtained.

### PRIOR ART DOCUMENT

### Patent Document

[Patent Document 1] Japanese Unexamined Patent Application Publication (Translation of PCT Application) No. 2020-525357
[Patent Document 2] Japanese Laid-Open Patent Application No. 2021-115992

### SUMMARY OF INVENTION

### Problems to be Solved by Invention

However, the method of solving the minimization problem by iterative calculation has a problem of a large calculation load. This problem is not limited to the field of a vehicle, but may occur in any field when a constraint minimization problem is to be solved.

With the foregoing problems in view, one of the objects of the present invention is to reduce a calculation load in solving a constraint minimization problem. In addition to the above object, an advantageous effect that is derived from each configuration shown in the following embodiment to carry out the present invention and that is not obtained by the conventional technique can be regarded as another object of the present disclosure.

### Means to Solve Problems of Invention

The arithmetic device and the vehicle control device disclosed herein are achieved in the embodiments and the application disclosed below and solve at least part of the above problems.

The arithmetic device disclosed herein obtains a minimizing solution of a predetermined evaluation function, the minimizing solution minimizing the evaluation function and satisfying a predetermined constraint, and includes a first arithmetic operator that sets at least one point on a boundary of the evaluation function obtained from the constraint as at least one of solution candidates and determines a solution that minimizes the evaluation function from among the solution candidates as a provisional solution; and a second arithmetic operator that calculates a solution that gives an extreme value of the evaluation function from a predetermined expression and specifies the minimizing solution based on the solution that gives the extreme value and the provisional solution, and obtains the minimizing solution without performing iterative calculation.

The vehicle control device disclosed herein includes: an arithmetic operator serving as the above arithmetic device; a first obtainer that obtains a signal defining a total braking and driving force of a vehicle and a total difference between left and right braking and driving forces; and a second obtainer that obtains estimated values or measured values of lateral forces and estimated values or measured values of vertical loads of respective wheels of the vehicle. The arithmetic operator calculates braking and driving forces of the respective wheel using minimizing solution obtained on the basis of the signal obtained by the first obtainer and the estimated values or the measured values obtained by the second obtainer. The evaluation function is a function that represents a sum of loads on the respective wheels, and the constraint includes not exceeding a maximum difference between left and right torques and a maximum torque of a front actuator that controls braking and driving forces of front wheels of the vehicle and not exceeding a maximum difference between left and right torques and a maximum torque of a rear actuator that controls braking and driving forces of rear wheels of the vehicle.

### Effect of Invention

The disclosed arithmetic device regards at least one point on a boundary obtained from a constraint as at least one of solution candidates and determines a solution that minimizes an evaluation function among the solution candidates as a provisional solution. Apart from the above, the disclosed arithmetic device calculates a solution that gives an extreme value of the evaluation function, and specifies the minimizing solution based on the solution that gives the extreme value and the provisional solution, so that the minimizing solution of the evaluation function can be obtained without iterative calculation. This makes it possible to reduce the calculation load in solving a constraint minimization problem.

Furthermore, according to the disclosed vehicle control device, an arithmetic operator serving as the above arithmetic device obtains the minimizing solution without iterative calculation, and calculates the braking and driving forces of the respective wheels using the obtained minimizing solution, so that the calculation load can be reduced in the calculation of the braking and driving force.

### BRIEF DESCRIPTION OF DRAWINGS

FIG. 1 is a diagram illustrating a configuration of a vehicle that adapts an arithmetic operator serving as an arithmetic device and a control device according to an embodiment;

FIG. 2 is a three-dimensional graph showing an evaluation function that the arithmetic operator (arithmetic device) of FIG. 1 solves;

FIG. 3 is a diagram illustrating a manner of obtaining a minimizing solution of the evaluation function;

FIG. 4 is a diagram illustrating a manner of obtaining a minimizing solution of the evaluation function;

FIG. 5 is a diagram illustrating a manner of obtaining a minimizing solution of the evaluation function;

FIG. 6 is a diagram showing a load displacement estimating model that the control device of FIG. 1 uses;

FIG. 7 is a diagram showing a load displacement estimating model that the control device of FIG. 1 uses;

FIG. 8 is a diagram showing a load displacement estimating model that the control device of FIG. 1 uses;

FIG. 9 is an example of a flow chart executed by the control device of FIG. 1; and

FIG. 10 is an example of a sub flow-chart of FIG. 9.

### EMBODIMENT TO CARRY OUT INVENTION

Description will now be made in relation to an arithmetic device and a vehicle control device according to an embodiment with reference to the accompanying drawings. The following embodiment is merely illustrative and is not intended to exclude the application of various modifications and techniques not explicitly described in the embodiment. The configuration of each embodiment can be variously modified without departing from the scope thereof. In addition, the configuration can be selected or omitted according to the requirement or appropriately combined.

The arithmetic device obtains a minimizing solution of a predetermined evaluation function which solution minimizes the evaluation function and also satisfies a predetermined constraint (constraint condition). The arithmetic device has a first arithmetic operator and a second arithmetic operator, and obtains a minimizing solution that minimizes the evaluation function without performing iterative calculation. The first arithmetic operator that sets at least one point on a boundary of the evaluation function obtained from the constraint as at least one of solution candidates and determines, as a provisional solution, a solution that minimizes the evaluation function among the solution candidates. Furthermore, the second arithmetic operator calculates a solution that gives an extreme value of the evaluation function from a predetermined expression and specifies the minimizing solution based on the calculated solution that gives the extreme value and the provisional solution determined by the first arithmetic operator. The above means that the arithmetic device narrows down the minimizing solution to a point on the boundary (provisional solution) and a solution that gives an extreme value and then specifies the minimizing solution, so that the minimizing solution can be specified without performing iterative calculation.

Here, an evaluation function J expressed in a bivariate function using two variables X₁ and X₂ is now exemplified. If the evaluation function J forms a graph in a substantially prolate spheroid surface projecting downward in a three-dimensional space consisting of an X₁ axis, an X₂ axis, and a J axis, and multiple constraints are provided, the functions giving the respective constraints are expressed respectively in linear functions including at least one of the two variables X₁ and X₂.

In this case, the first arithmetic operator of the arithmetic device calculates, as the solution candidate, an intersection of liner functions (boundaries) intersecting with each other and also calculates, as the solution candidate, a contact point of a plane (boundary) with an isogram when the isogram of the evaluation function J is defined so as to be in contact with the plane serving as the boundary expressed by a linear function in the above three-dimensional space (X₁-X₂-J space). Furthermore, the first arithmetic operator regards a set of combinations each containing the two variables X₁ and X₂ satisfying all the constraints as an executable range S, and determines, as the provisional solution, one of solution candidates within the executable range S, the one solution candidate minimizing a value obtained by being substituted into the evaluation function.

In addition, if the solution that gives the extreme value of the evaluation function is within the executable range S, the second arithmetic operator of the arithmetic device specifies the solution that gives the extreme value as the minimizing solution. In contrast, if the solution that gives the extreme value of the evaluation function is outside the executable range S, the second arithmetic operator of the arithmetic device specifies the provisional solution determined by the first arithmetic operator as the minimizing solution. The above “boundary” means the boundary of the executable range S determined from the constraints, and the phrase “within the executable range S” refers to inside and on the boundary of the executable range S.

The evaluation function handled by the arithmetic device is not particularly limited. For example, if the arithmetic device is applied to a vehicle, an example of the evaluation function may represent the sum of the loads on the respective wheels of the vehicle. In addition, setting the sum of squares of forces to be generated by an actuator for posture control to the evaluation function and calculating the control amount that minimizes the value of the evaluation function make it possible to reduce the energy consumption, therefore, the arithmetic device may be used to obtain the minimizing solution that minimizes this evaluation function.

Hereinafter, assuming that the arithmetic device is applied to a vehicle, the description will now be made in relation to the configurations of the arithmetic device and the vehicle control device. In the following explanation, a direction in which a vehicle moves forward is referred to as front (vehicle front), and the left and right directions are defined on the basis of the front.

### [1. Device Configuration]

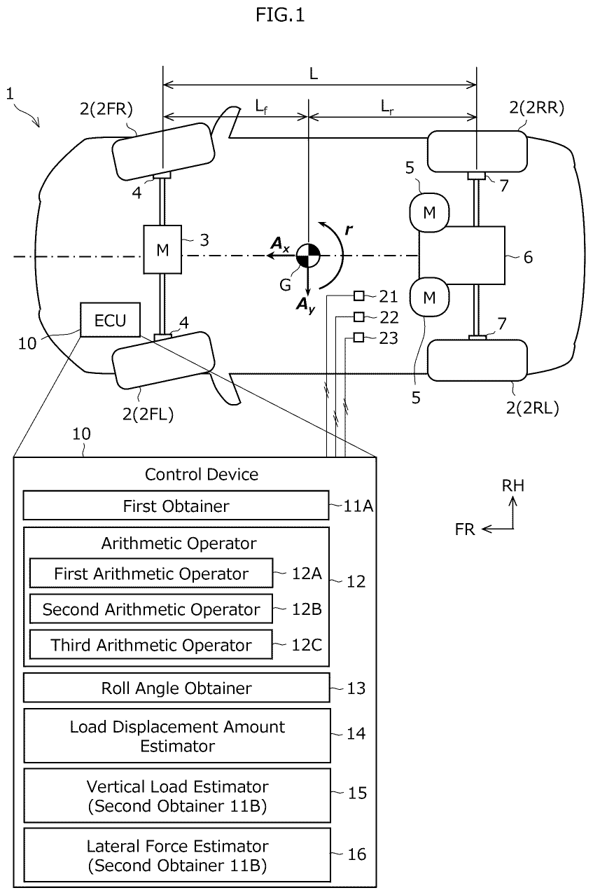

A control device 10 of the present embodiment is applied to a vehicle 1 illustrated in FIG. 1, at least has a function as an arithmetic device that calculates a braking force and a driving force (hereinafter also referred to as a “braking and driving force”) of each wheel 2 of the vehicle 1, and preferably has a function of estimating a vertical load (also referred to as a grounding load and a wheel load) and a lateral force of each wheel 2. The control device 10 is a device achieved by one of the electronic control units (ECUs) mounted on the vehicle 1. The control device 10 includes, for example, a processor (microprocessor) such as a CPU (Central Processing Unit) and an MPU (Micro Processing Unit), a ROM (Read Only Memory), a RAM (Random Access Memory), and a non-volatile memory.

The processor is an arithmetic processor including, for example, a control unit (controlling circuit), an arithmetic unit (arithmetic circuit), and a cache memory (register group). The ROM, the RAM, and the non-volatile memory are memory devices in which program and data in operation are stored. The contents of the arithmetic operations performed by the control device 10 are recorded and stored as firmware or an application program in the memory, and when the program is to be executed, the contents of the program are expanded in a memory space and executed by the processor.

The vehicle 1 of the present embodiment is an electric vehicle, such as an EV (Electric Vehicle), an HEV (Hybrid Electric Vehicle), a PHEV (Plug-in Hybrid Electric Vehicle), provided with a front motor 3 that drives front wheels 2F and two rear motors 5 that drive rear wheels 2R as drive forces, and is further provided with a differential device 6 that applies a torque difference to the left and right rear wheels 2R. The differential device 6 is a power distribution device having a function of amplifying the torque difference between the two rear motors 5 and then distributing the torque to the respective rear wheels 2R.

The differential device 6 is a differential mechanism having a yaw control function (AYC function), and is interposed between an axle connected to the rear left wheel 2RL and an axle connected to the rear right wheel 2RR. The yaw control function is a function to adjust the yaw moment by positively controlling the sharing ratio of the driving forces (driving torques) of the left and right rear wheels 2R and thereby stabilize posture of the vehicle 1. In the differential device 6, a planetary gear mechanism, a differential gear, and the like are incorporated. A vehicle driving device including the pair of rear motors 5 and the differential device 6 is also referred to as a DM-AYC (Dual-Motor Active Yaw Control) device.

Further, the vehicle 1 of the present embodiment includes, as braking devices, front brake devices 4 that brake the front wheels 2F and rear brake devices 7 that brake the rear wheels 2R, and the wheels 2 are subjected to brake control independently of each other. Each front brake device 4 of the present embodiment is provided with a yaw control function (AYC function). Further, a non-illustrated driving battery is mounted on the vehicle 1. Hereinafter, the front motor 3 and the front brake devices 4 that control the braking and driving forces of the front wheels 2F are collectively referred to as a “front actuator”, and the rear motors 5, the differential device 6, and the rear brake devices 7 that control the braking and driving forces of the rear wheels 2R are collectively referred to as a “rear actuator”.

These devices 3 to 7 are individually controlled by non-illustrated on-board control devices. For example, a motor control device that controls the front motor 3 and the rear motors 5, and a brake control device that controls the front brake devices 4 and the rear brake devices 7 are mounted on the vehicle 1. In the present embodiment, a result of arithmetic operation performed by the control device 10 is sent to various control devices and is used to control the devices 3 to 7. The control device 10 may be additionally provided with a function of controlling the devices 3 to 7.

The vehicle 1 is provided with sensors that obtain various types of data of the vehicle 1. In the example shown in FIG. 1, a yaw rate sensor 21, a lateral acceleration sensor 22, and a longitudinal acceleration sensor 23 are provided, and the sensors 21 to 23 are each connected to control device 10. The yaw rate sensor 21 (yaw rate detecting means) is a sensor that detects, as a yaw rate r, the rotational angular velocity around the vertical axis passing through center G of gravity of the vehicle 1. In the present embodiment, as indicated by thick arrows in FIG. 1, the positive direction of the yaw rate r is a counterclockwise direction around the center G of gravity when the vehicle 1 is viewed from above.

The lateral acceleration sensor 22 (lateral acceleration detecting means) and the longitudinal acceleration sensor 23 (longitudinal acceleration detecting means) are sensors that detect a lateral acceleration A_{y} and a longitudinal acceleration Aₓ at the center G of gravity of the vehicle 1, respectively. In the present embodiment, as indicated by the thick arrows in FIG. 1, the positive direction of the lateral acceleration A_{y} is a leftward direction from the center G of gravity, and the positive direction of the longitudinal acceleration Aₓ is a direction from the center G of gravity toward the front. The data detected by the sensors 21 to 23 are sent to the control device 10. In addition to these sensors 21 to 23, the vehicle 1 is provided with general-purpose sensors such as an accelerator opening sensor (accelerator position sensor), a brake sensor, a vehicle speed sensor, a wheel speed sensor, and a steering angle sensor.

The means for detecting the yaw rate r, the means for detecting the lateral acceleration A_{y}, and the means for detecting the longitudinal acceleration Aₓ are not limited to the yaw rate sensor 21, the lateral acceleration sensor 22, and the longitudinal acceleration sensor 23, respectively. For example, the lateral acceleration A_{y} may be detected (obtained) by estimating the lateral acceleration A_{y} based on the steering angle or the vehicle speed V, or by correcting the estimated value or the value detected by the lateral acceleration sensor 22 based on another sensor value. Similarly, the yaw rate r and the longitudinal acceleration Aₓ may be detected (obtained) by correcting a value detected by the yaw rate sensor 21 and a value detected by the longitudinal acceleration sensor 23, respectively, based on other sensor values. In such cases, an estimator and a corrector (the functional element of the control device) can serve as the respective detecting means.

### [2. Control Configuration]

The control device 10 includes a first obtainer 11B a second obtainer 11B, and an arithmetic operator 12 that serve as functional elements that calculate the braking and driving forces X₁ to X₄ of the respective wheels 2 based on total braking and driving force Xₜₒₜₐₗ of the vehicle 1, total difference Δₜₒₜₐₗ between left and right braking and driving forces of the vehicle 1, lateral forces Y₁ to Y₄ of the respective wheels 2, and vertical loads Z₁ to Z₄ of the respective wheels 2. These elements are classification of the functions of the control device 10 for the sake of convenience. These elements may be each described as an independent program and may also be described as a combined program of multiple elements. The program corresponding to each element is stored in the memory or the storage device of the control device 10 and executed by the processor. The total braking and driving force Xₜₒₜₐₗ is the sum of the left and right braking forces and the left and right driving forces, and the total difference Δₜₒₜₐₗ between left and right braking and driving forces is the sum of the difference of the braking force and the driving force on the left side and the braking force and the driving force on the right side (the sum of the difference of the front side and the difference of the rear side).

The control device 10 of the present embodiment also has a function of calculating the lateral forces Y₁ to Y₄ and the vertical loads Z₁ to Z₄ of the respective wheels 2 to be used in the calculation of the braking and driving forces X₁ to X₄. Specifically, the control device 10 includes a roll angle obtainer 13, a load displacement amount estimator 14, and a vertical load estimator 15 as functional elements for calculating the vertical loads Z₁ to Z₄, and includes a lateral force estimator 16 as a functional element for calculating the lateral forces Y₁ to Y₄. These elements are also classification of the functions of the control device 10 for convenience like the above elements 11A, 11B, and 12.

To the reference signs representing the braking and driving forces X₁ to X₄, the lateral forces Y₁ to Y₄, and the vertical loads Z₁ to Z₄, under subscripts 1 to 4 are attached so as to correspond to, in sequence, the front left wheel 2FL, the front right wheel 2FR, the rear left wheel 2RL, and the rear right wheel 2RR.

The following description will be made in relation to, first, the calculation of the braking and driving forces X₁ to X₄, and then the calculation of the lateral forces Y₁ to Y₄ and the vertical loads Z₁ to Z₄.

### [2-1. Calculation of Braking and Driving Force]

The first obtainer 11A obtains signal(s) that define the total braking and driving force Xₜₒₜₐₗ and the total difference Δₜₒₜₐₗ between left and right braking and driving forces of the vehicle 1. The first obtainer 11A of the present embodiment obtains demanded torque N and demanded yaw moment Q, obtains the total braking and driving force Xₜₒₜₐₗ from the demanded torque N using the following Equation 1, obtains the total difference Δₜₒₜₐₗ between left and right braking and driving forces from the demanded yaw moment Q, and obtains them as a signal defining the total braking and driving force Xₜₒₜₐₗ and the total difference Δₜₒₜₐₗ between left and right braking and driving forces respectively. In Equation 1, the symbol R represents a radius of a tire, and the symbol T represents tread.

$$\begin{matrix}[ Math . 1 ] & \\ {X}_{total} = \frac{N}{R} {Δ}_{total} = \frac{Q}{T / 2} & ( Equation 1 )\end{matrix}$$

The demanded torque N and the demanded yaw moment Q are control command values calculated by a control device different from the control device 10, for example, and are calculated on the basis of the driver operation (e.g., accelerator opening, shift position, traveling mode) and the vehicle condition. Alternatively, the control device 10 may calculate the demanded torque N and the demanded yaw moment Q, and the first obtainer 11A may obtain the signal defining the total braking and driving force Xₜₒₜₐₗ and the total difference Δₜₒₜₐₗ between left and right braking and driving forces. The method of obtaining the signal defining the total braking and driving force Xₜₒₜₐₗ and the total difference Δₜₒₜₐₗ between left and right braking and driving forces of the vehicle 1 are not limited the above. Alternatively, the signal defining the total braking and driving force Xₜₒₜₐₗ and the total difference Δₜₒₜₐₗ between left and right braking and driving forces may be directly obtained, or the total braking and driving force Xₜₒₜₐₗ and the total difference Δₜₒₜₐₗ between left and right braking and driving forces may be calculated by obtaining a total braking and driving output and an output difference between left and right output braking and driving forces.

The second obtainer 11B obtains estimated values or measured values of the lateral forces Y₁ to Y₄ and the vertical loads Z₁ to Z₄ of the respective wheels 2 of the vehicle 1. In the control device 10 of the present embodiment, a vertical load estimator 14 and a lateral force estimator 15 serving as the second obtainer 11B are provided. This means that the second obtainer 11B of the present embodiment obtains estimated values of the lateral forces Y₁ to Y₄ and the vertical loads Z₁ to Z₄. If a process of estimating the lateral forces Y₁ to Y₄ and the vertical loads Z₁ to Z₄ described below is omitted, it is sufficient that the second obtainer 11B obtains the measured values of the lateral forces Y₁ to Y₄ and the vertical loads Z₁ to Z₄.

The arithmetic operator 12 calculates (estimates) the braking and driving forces X₁ to X₄ of the respective wheels 2 based on the signal defining the total braking and driving force Xₜₒₜₐₗ and the total difference Δₜₒₜₐₗ between left and right braking and driving forces obtained by the first obtainer 11A and the estimated or measured values of the lateral forces Y₁ to Y₄ and the vertical loads Z₁ to Z₄ by the second obtainer 11B. The control device 10 of the present embodiment provides the arithmetic operator 12 with a function of an arithmetic device capable of specifying a minimizing solution without performing the above-described iterative calculation. In other words, the control device 10 includes the arithmetic operator 12 serving as the above arithmetic device.

In relation to a predetermined evaluation function J, the arithmetic operator 12 obtains the minimizing solution that minimizes the evaluation function J and that also satisfies predetermined constrains without performing iterative calculation. Then, the obtained minimizing solution is used in the calculation of the braking and driving forces X₁ to X₄. The evaluation function J of the present embodiment is given as a function representing the total sum of the loads on the respective wheels 2. Specifically, as shown in the following Equation 2, the evaluation function J is expressed in the sum of four values (one for each of the four wheels) each of which is calculated by dividing the sum of the square of the braking and driving force of each wheel 2 and the square of the lateral force of the wheel 2 by the square of the vertical load of the wheel 2 (i.e., each of the four values represents a ratio of friction force generated on each wheel 2 to the friction force on the wheel 2). In other words, the evaluation function is represented by the sum of the square of each ratio of the friction force generated on the each wheel 2 to the vertical load on the wheels 2. As described above, by obtaining the braking and driving forces X₁ to X₄ that minimize the evaluation function J, the tire slippage can be prevented.

$$\begin{matrix}[ Math . 2 ] & \\ J = {\sum }_{\text{?} = 1}^{4} \frac{{X}_{i}^{2} + {Y}_{i}^{2}}{{Z}_{i}^{2}} & ( Equation 2 )\end{matrix}$$

$$\text{?} \text{indicates text missing or illegible when filed}$$

The control device 10 of the present embodiment sets the following four constraints.
Constraint 1: To satisfy a demanded total braking and driving force of the vehicle 1.
Constraint 2: To satisfy a demanded total difference between left and right braking and driving forces.
Constraint 3: Not to exceed a maximum difference between left and right torques of the front actuator and also not to exceed a maximum torque of the front actuator.
Constraint 4: Not to exceed a maximum difference between left and right torques of the rear actuator and also not to exceed a maximum torque of the rear actuator.

The constraints 1 and 2 are represented by Equations 3 and 4, respectively. In Equation 4, the symbol X_{L} represents a left braking and driving force (X_{L}=X₁+X₃) and the symbol X_{R} represents a right braking and driving force (X_{R}=X₂+X₄).

$$\begin{matrix}[ Math . 3 ] & \\ Demanded total braking and driving force = {\sum }_{\text{?} = 1}^{4} {X}_{i} & ( Equation 3 )\end{matrix}$$

$$Demanded total difference between left and right braking and driving forces = \frac{T}{2} ( {X}_{R} - {X}_{L} ) \qquad ( Equation 4 )$$

$$\text{?} \text{indicates text missing or illegible when filed}$$

The constraint 3 is represented by the following five expressions (collectively, Equation 5). In Equation 5, the symbol X_{FMAX} represents an absolute value of a maximum front braking and driving force, and the symbol Δ_{FMAX} is an absolute value of a maximum difference between front braking and driving forces, both of which may be calculated by the control device 10 or by a control device different from the control device 10. The function (boundary) that gives the constraint 3 is expressed in a linear function F (X₁, X₂) including at least one of the two variables X₁, and X₂ as shown in Equation 5 below.

$$\begin{matrix}[ Math . 4 ] & \\ \{ \begin{matrix}{X}_{1} + {X}_{2} \leq {X}_{1} - {X}_{2} + {X}_{FMAX} \\ {X}_{1} + {X}_{2} \leq - ( {X}_{1} - {X}_{2} ) + {X}_{FMAX} \\ {X}_{1} + {X}_{2} \geq {X}_{1} - {X}_{2} - {X}_{FMAX} \\ {X}_{1} + {X}_{2} \geq - ( {X}_{1} - {X}_{2} ) - {X}_{FMAX} \\ \vert {X}_{1} - {X}_{2} \vert \leq {Δ}_{FMAX}\end{matrix} & ( Equation 5 )\end{matrix}$$

The constraint 4 is represented by the following four expressions (collectively, Equation 6). In Equation 6, the symbol X_{RMAX} represents an absolute value of a maximum rear braking and driving force, and the symbol Δ_{RMAX} is an absolute value of a maximum difference between rear braking and driving forces, both of which may be calculated by the control device 10 or by a control device different from the control device 10.

$$\begin{matrix}[ Math . 5 ] & \\ \{ \begin{matrix}{X}_{3} + {X}_{4} \leq \frac{{X}_{RMAX}}{{Δ}_{RMAX}} ( {X}_{3} - {X}_{4} ) + {X}_{RMAX} \\ {X}_{3} + {X}_{4} \leq - \frac{{X}_{RMAX}}{{Δ}_{RMAX}} ( {X}_{3} - {X}_{4} ) + {X}_{RMAX} \\ {X}_{3} + {X}_{4} \geq \frac{{X}_{RMAX}}{{Δ}_{RMAX}} ( {X}_{3} - {X}_{4} ) - {X}_{RMAX} \\ {X}_{3} + {X}_{4} \geq - \frac{{X}_{RMAX}}{{Δ}_{RMAX}} ( {X}_{3} - {X}_{4} ) - {X}_{RMAX}\end{matrix} & ( Equation 6 )\end{matrix}$$

Since the following equations X_{L}=X₁+X₃ and X_{R}=X₂+X₄ are established, the braking and driving forces X₃ and X₄ of rear wheels 2R can be eliminated from Equation 6 by substituting the relationships of Equations 3 and 4 into Equation 6. As a result, the boundary of the constraint 4 is also expressed in a linear function F (X₁, X₂) including at least one of the two variables X₁ and X₂, as shown in Equation 6′.

$$\begin{matrix}[ Math . 6 ] & \\ \{ \begin{matrix}{X}_{1} + {X}_{2} \geq \frac{{X}_{RMAX}}{{Δ}_{RMAX}} \{ ( {X}_{1} - {X}_{2} ) - {Δ}_{total} \} + {X}_{total} - {X}_{RMAX} \\ {X}_{1} + {X}_{2} \geq - \frac{{X}_{RMAX}}{{Δ}_{RMAX}} \{ ( {X}_{1} - {X}_{2} ) - {Δ}_{total} \} + {X}_{total} - {X}_{RMAX} \\ {X}_{1} + {X}_{2} \leq \frac{{X}_{RMAX}}{{Δ}_{RMAX}} \{ ( {X}_{1} - {X}_{2} ) - {Δ}_{total} \} + {X}_{total} + {X}_{RMAX} \\ {X}_{1} + {X}_{2} \leq - \frac{{X}_{RMAX}}{{Δ}_{RMAX}} \{ ( {X}_{1} - {X}_{2} ) - {Δ}_{total} \} + {X}_{total} + {X}_{RMAX}\end{matrix} & ( Equation {6}^{′} )\end{matrix}$$

Further, by substituting the relationships of X_{L}=X₁+X₃ and X_{R}=X₂+X₄ into Equation 2, the braking and driving forces X₃ and X₄ of the rear wheels 2R can be eliminated from Equation 2.

$$\begin{matrix}[ Math . 7 ] & \\ \begin{matrix}J = \frac{{X}_{1}^{2} + {Y}_{1}^{2}}{{Z}_{1}^{2}} + \frac{{X}_{2}^{2} + {Y}_{2}^{2}}{{Z}_{2}^{2}} + \frac{{X}_{3}^{2} + {Y}_{3}^{2}}{{Z}_{3}^{2}} + \frac{{X}_{4}^{2} + {Y}_{4}^{2}}{{Z}_{4}^{2}} \\ = \frac{{X}_{1}^{2} + {Y}_{1}^{2}}{{Z}_{1}^{2}} + \frac{{X}_{2}^{2} + {Y}_{2}^{2}}{{Z}_{2}^{2}} + \frac{{( {X}_{L} - {X}_{1} )}^{2} + {Y}_{3}^{2}}{{Z}_{3}^{2}} + \frac{{( {X}_{R} - {X}_{2} )}^{2} + {Y}_{4}^{2}}{{Z}_{4}^{2}} \\ = {a}_{2} {X}_{1}^{2} + {a}_{1} {X}_{1} + {b}_{2} {X}_{2}^{2} + {b}_{1} {X}_{2} + C \\ = {{a}_{2} ( {X}_{1} + \frac{{a}_{1}}{2 {a}_{2}} )}^{2} + {{b}_{2} ( {X}_{2} + \frac{{b}_{1}}{2 {b}_{2}} )}^{2} + {C}^{′}\end{matrix} & ( Equation 7 )\end{matrix}$$

Since the total braking and driving force Xₜₒₜₐₗ is represented by Xₜₒₜₐₗ=X_{L}+X_{R} and the total difference Δₜₒₜₐₗ between left and right braking and driving forces is represented by Δₜₒₜₐₗ=X_{R}-X_{L}, the left braking and driving force X_{L} and the right braking and driving force X_{R} are expressed with the total braking and driving force Xₜₒₜₐₗ and the total difference Δₜₒₜₐₗ between left and right braking and driving forces as shown in following Equations 8.

$$\begin{matrix}[ Math . 8 ] & \\ {X}_{L} = \frac{{X}_{total} - {Δ}_{total}}{2} , {X}_{R} = \frac{{X}_{total} + {Δ}_{total}}{2} & ( Equation 8 )\end{matrix}$$

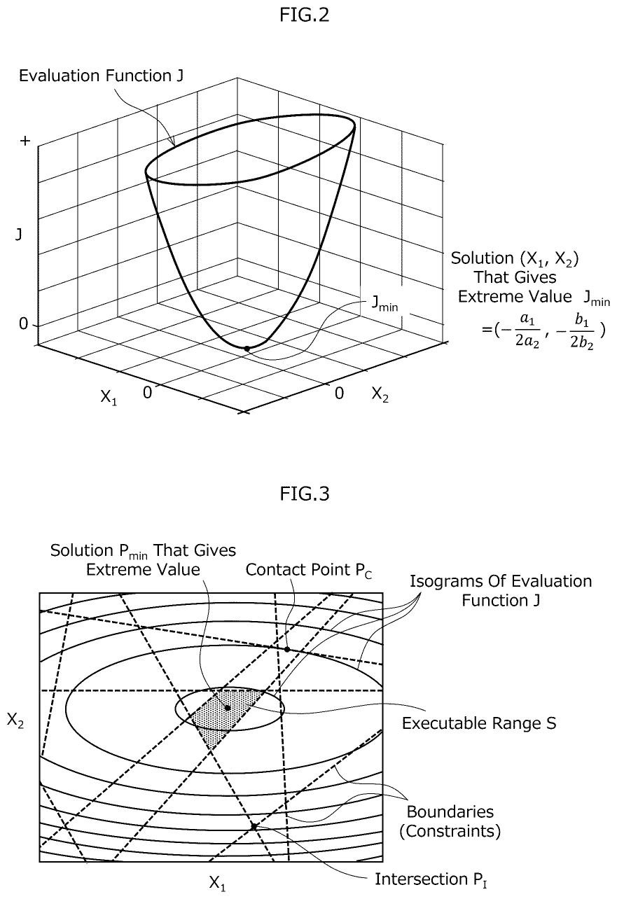

As shown in above Equation 7, the evaluation function J is expressed in a bivariate function in which the braking and driving forces of the respective front wheels 2F are set to variables X₁ and X₂. As shown in FIG. 2, the evaluation function J forms a graph in a substantially prolate spheroid surface (bowl shape) projecting downward in a three-dimensional space having an X₁ axis, an X₂ axis, and a J axis. Specifically, the evaluation function J forms a curved surface having (X₁, X₂)=((−a₁/2a₂), (−b₁/2b₂)) as an axis of symmetry, and has isograms (cross-sectional shapes perpendicular to the J axis) with respect to the J axis in the shape of ellipse. A minimizing solution P (X₁, X₂) of the evaluation function when the constrains are absent corresponds to the coordinate {(−a₁/2a₂), (−b₁/2b₂)} of the point positioned at the vertex (i.e., extreme value) of the graph. However, since above constraints are actually present, the arithmetic operator 12 obtains a point (minimizing solution P) that minimizes evaluation function J from points satisfying the predetermined constraints without performing iterative calculation.

The arithmetic operator 12 serving as the arithmetic device includes the first arithmetic operator 12A, the second arithmetic operator 12B, and the third arithmetic operator 12C. The first arithmetic operator 12A sets at least one point on a boundary obtained from the constraints as one of solution candidates and determines, as a provisional solution, a solution that minimizes the evaluation function J among the solution candidates. The boundary is a boundary (boundary line or boundary surface) of an executable range S obtained from the constraints.

The second arithmetic operator 12B calculates an extreme value Jₘᵢₙ of the evaluation function J from a given equation and specifies the minimizing solution P based on a point Pₘᵢₙ (hereinafter “solution Pₘᵢₙ that gives the extreme value) that takes this extreme value Jₘᵢₙ and the provisional solution determined by the first arithmetic operator 12A. The third arithmetic operator 12C calculates the braking and driving forces X₁ to X₄ of the respective wheels 2 using the minimizing solution P. Hereinafter, a method of obtaining the minimizing solution P of the evaluation function J will now be described with reference to FIG. 3 to FIG. 5.

FIG. 3 to FIG. 5 are figures seen from the positive direction (from above in FIG. 2) of the J axis downward the X₁X₂ plane (a plane of the X₁ axis and the X₂ axis). The ellipses in FIG. 3-FIG. 5 represent the isograms of the evaluation function J, and an extreme value Jₘᵢₙ is the apex of the graph of the evaluation function J. The thick dashed lines in the drawings are each boundaries defined by linear functions (straight lines F) that give the constraints. Each thick dashed line is a straight line when viewed with respect to the X₁X₂ plane, but is represented by a plane parallel to the J axis when being viewed in a three-dimensional space (X₁-X₂-J space) as shown in FIG. 2. In addition, the executable ranges S enclosed by the dotted patterns in the drawings are a set of points (combinations of) (X₁, X₂) satisfying all the constraints, and the minimizing solution P to be obtained is present in this executable range S. The ellipses and straight lines in FIG. 3 to FIG. 5 are mere examples.

The first arithmetic operator 12A calculates, as solution candidates, intersections P_{I} of linear functions (straight lines F) intersecting with each other and contact points P_{c} of the above plane (boundary) with isograms of the evaluation function J. Here, the contact point P_{c} is one when the ellipse E defined by the following Equation 9 is in contact with the straight line F. The symbol E in Equation 9 represents an arbitrary real number.

$$\begin{matrix}[ Math . 9 ] & \\ {{a}_{2} ( {X}_{1} + \frac{{a}_{1}}{2 {a}_{2}} )}^{2} + {{b}_{2} ( {X}_{2} + \frac{{b}_{1}}{2 {b}_{2}} )}^{2} = E & ( Equation 9 )\end{matrix}$$

Although in FIG. 3 to FIG. 5, some of the intersections P_{I} and the contact points P_{c} are attached with reference numbers, the first arithmetic operator 12A calculates all intersections P_{I} and all contact points P_{c} as solution candidates. The intersection P_{I} is the point at which the straight lines intersect with each other on the X₁X₂ plane, and the contact point P_{c} is contact point between the boundary and the isogram when the isogram of the evaluation function J is defined so as to be in contact with the linear function (boundary) in the X₁-X₂-J space.

The first arithmetic operator 12A further sets the above-described executable range S, and calculates the value of J by substituting each of the solution candidates (intersections P_{I}, contact points P_{c}) within the executable range S into the evaluation function J [for example, substituting the value of the coordinate (X₁, X₂) of the intersection P_{I} into Equation 7]. Then, the first arithmetic operator 12A determines, as a provisional solution, one of the solution candidates (X₁, X₂) the calculated value of which is the minimum.

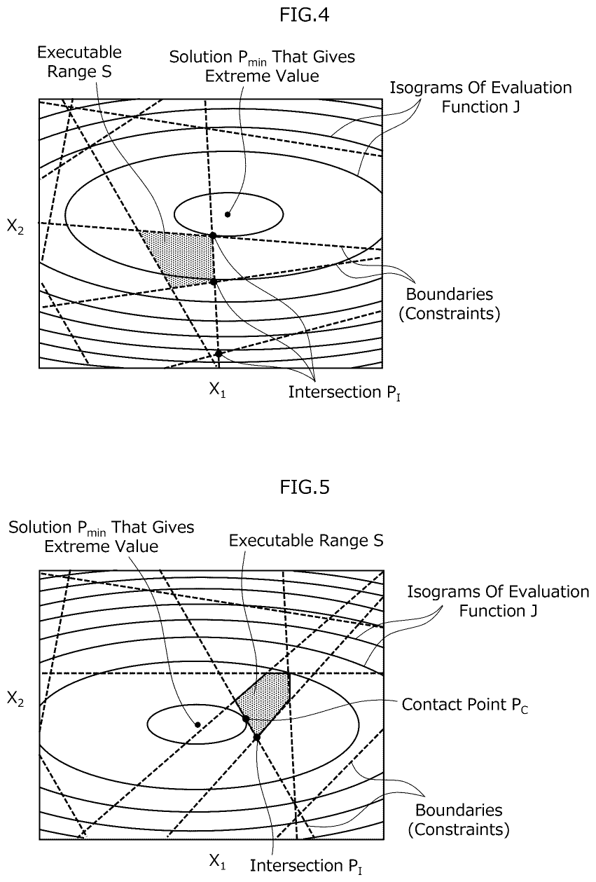

The second arithmetic operator 12B compares the provisional solution defined as the above with the solution Pₘᵢₙ that gives an extreme value of the evaluation function J and specifies either one of them as the minimizing solution P. Specifically, as shown in FIG. 3, if the solution Pₘᵢₙ that gives the extreme value is within the executable range S (inside the executable range S or on the boundary of the executable range S), the second arithmetic operator 12B specifies the solution Pₘᵢₙ that gives the extreme value to be the minimizing solution P (i.e., minimizing solution P=Pₘᵢₙ). On the other hand, as shown in FIG. 4 and FIG. 5, if the solution Pₘᵢₙ that gives the extreme value is outside the executable range S, the second arithmetic operator 12B specifies the provisional solution (the intersection P_{I} or the contact point P_{c}) to be the minimizing solution P (minimizing solution P=P_{I} or P_{c}).

The third arithmetic operator 12C sets the specified minimizing solution P (X₁, X₂) to the braking and driving force X₁ of the front left wheel 2FL and the braking and driving force X₂ of the front right wheel 2FR. Also, since the relationships X_{L}=X₁+X₃ and X_{R}=X₂+X₄ are established, the third arithmetic operator 12C calculates the braking and driving force X₃ of the rear left wheel 2RL and the braking and driving force X₄ of the rear right wheel 2RR from the relationship between minimizing solution P (X₁, X₂) and the above Equation 8.

### [2-2. Estimation of Vertical Load and Lateral Force]

Next, description will now be made in relation to estimation of the lateral forces Y₁ to Y₄ and the vertical loads Z₁ to Z₄ performed by the control device 10. The present embodiment assumes that the values of the lateral forces Y₁ to Y₄ and the vertical loads Z₁ to Z₄ estimated here are used for the estimation of the above braking and driving forces X₁ to X₄, but the estimated values of the lateral forces Y₁ to Y₄ and the vertical loads Z₁ to Z₄ can be used for various vehicle motion control (e.g., control of a power steering device, control of a steering angle such as AFS and ARS, and control of the active suspension and the notifying device). The above braking and driving forces X₁ to X₄ may be estimated by using lateral forces Y₁ to Y₄ and vertical loads Z₁ to Z₄ estimated and obtained in a method except for the method to be described below.

The roll angle obtainer 13 obtains a roll angle θ of the vehicle 1. The method of obtaining the roll angle θ is not particularly limited, and as well as the above-described sensors 21 to 23, a sensor capable of detecting the roll angle θ may be provided, and a sensor value and a corrected value of the sensor value may be obtained as the roll angle θ. Alternatively, the value (roll angle θ) may be obtained by estimating the roll angle θ based on a sensor value and the vehicle specifications. Here, a latter scheme, i.e., a method of obtaining the roll angle θ by estimation will now be described.

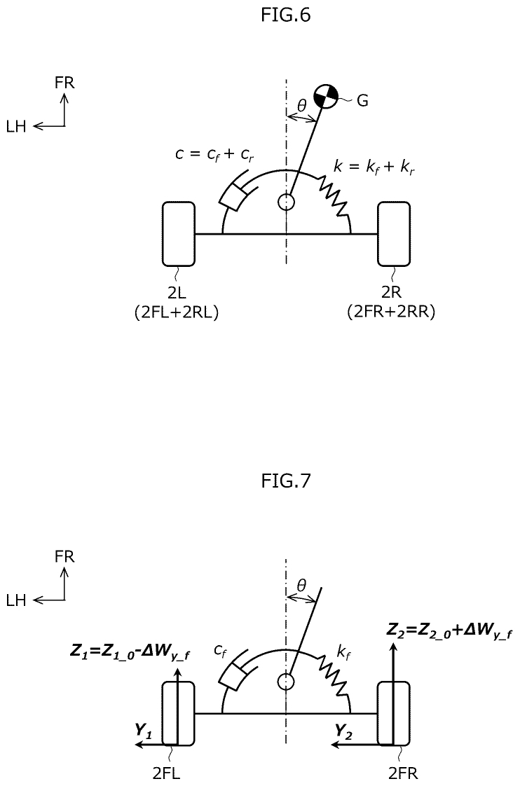

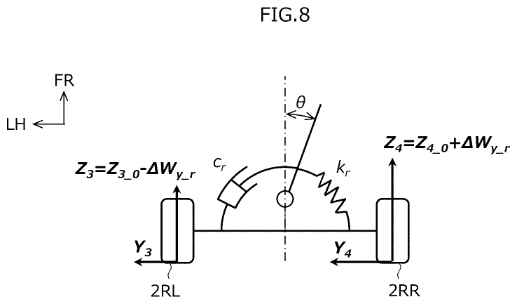

The roll angle obtainer 13 estimates the roll angle θ of the vehicle 1 based on the lateral acceleration A_{y} detected by the lateral acceleration sensor 22 and a vehicle roll damping coefficient c (=c_{f}+cᵣ), which is the sum of a front-wheel roll damping coefficient of for the front wheels 2F and a rear-wheel roll damping coefficient cᵣ for the rear wheels 2R. As shown in FIG. 6, the vehicle roll damping coefficient c is the damping coefficient in the roll direction, the front-wheel roll damping coefficient of is the part of the damping coefficient in the roll direction that is handled by the front axle as shown in FIG. 7, and the rear-wheel roll damping coefficient or is the part of the damping coefficient in the roll direction that is handled by the rear axle, as shown in FIG. 8. FIG. 6 to FIG. 8 model the vehicle 1 (into a load displacement model), making the vehicle 1 resemble a pendulum, FIG. 6 shows a model viewed from the rear surface of the vehicle, FIG. 7 shows a model cut along the center line of the front axle, and FIG. 8 shows a model cut along the center line of the rear axle.

The roll angle obtainer 13 of the present embodiment estimates (calculates) the roll angle θ from the following Equation 10, using the model of FIG. 6. In Equation 10, the symbol m represents a vehicle weight, the symbol h represents a roll diameter, the symbol Iₓ represents a roll moment of inertia, the symbol k represents vehicle rolling stiffness, and the symbol g represents the gravitational acceleration, all of which are fixed values. The roll damping coefficients c_{f} and cᵣ of the front and rear wheels are mapped in advance as constants with respect to the roll angular velocity, for example, and are obtained by applying the roll angular velocity to the maps. The roll angular velocity may be obtained by, for example, differentiating the estimated roll angle θ, or may be a sensor value. The vehicle rolling stiffness k is the sum of a front-wheel rolling stiffness k_{f} relative to the front wheels 2F and a rear-wheel rolling stiffness kᵣ relative to the rear wheels 2R. The rolling stiffnesses k_{f} and kᵣ of the front and rear wheels are fixed values, and the symbol s represents a Laplace operator.

$$\begin{matrix}[ Math . 10 ] & \\ θ ( s ) = \frac{mh}{{I}_{x} {s}^{2} + cs + k - mgh} {A}_{y} ( s ) & ( Equation 10 )\end{matrix}$$

The load displacement amount estimator 14 estimates a load displacement amount ΔW_{y_f} (hereinafter, referred to as afront-wheel side load displacement amount ΔW_{y_f}) between the left and right wheels of the front wheels 2F and a load displacement amount ΔW_{y_r} (hereinafter referred to as arear-wheel side load displacement amount ΔW_{y_r}) between the left and right wheels of rear wheels 2R. The front-wheel side load displacement amount ΔW_{y_f} is estimated on the basis of the roll angle θ obtained by the roll angle obtainer 13, the lateral force Y_{f} of the front wheels 2F, the front-wheel roll damping coefficient c_{f}, and the front-wheel rolling stiffness k_{f}. Similarly, the rear-wheel side load displacement amount ΔW_{y_r} is estimated based on the roll angle θ obtained by the roll angle obtainer 13, the lateral force Yᵣ of the rear wheels 2R, the rear-wheel roll damping coefficient cᵣ, and the rear-wheel rolling stiffness kᵣ.

The lateral force Y_{f} of the front wheels 2F is the sum of the lateral force Y₁ of the front left wheel 2FL and the lateral force Y₂ of the front right wheel 2FR (i.e., Y_{f}=Y₁+Y₂), and the lateral force Yᵣ of the rear wheels 2R is the sum of the lateral force Y₃ of the rear left wheel 2RL and the lateral force Y₄ of the rear right wheel 2RR (Yᵣ=Y₃+Y₄). As will be described below, the respective lateral forces Y_{f} and r Yᵣ of the front and rear wheels 2F and 2R used in the above calculation are preferably ones estimated by the load displacement amount estimator 14.

The load displacement amount estimator 14 of the present embodiment estimates the front-wheel side load displacement amount ΔW_{y_f} from the following Equation 11, which is a balance equation of the moment acting around the roll center of the front wheels 2F, using the model of FIG. 7. Specifically, the front-wheel side load displacement amount ΔW_{y_f} is estimated (calculated) by solving Equation 10 for the front-wheel side load displacement amount ΔW_{y_f} and then using the Equation 12 obtained by Laplace transformation.

In Equations 11 and 12, the symbol T represents the tread (front tread) and the symbol h_{f} represents the height of the roll center of the front wheels 2F (the height from the ground to the roll center), both of which are fixed values. In Equation 11, the symbols Z_{1_0} and Z_{2_0} represent vertical loads on the front left and right wheels 2FL and 2FR when vehicle is stopped, respectively. These values of Z_{1_0} and Z_{2_0} may be, for example, predetermined fixed values or estimated values estimated from stroke sensor values of suspensions or the like. These values of Z_{1_0} and Z_{2_0} do not necessarily have to be equal to each other.

$$\begin{matrix}[ Math . 11 ] & \\ {k}_{f} θ + {c}_{f} \frac{d}{dt} θ + {h}_{\text{?}} {Y}_{\text{?}} + ( {Z}_{1 \_ 0} - Δ {W}_{\text{?}} ) \cdot \frac{T}{2} - ( {Z}_{2 \_ 0} + Δ {W}_{\text{?}} ) \cdot \frac{T}{2} = 0 & ( Equation 11 )\end{matrix}$$

$$Δ {W}_{\text{?}} ( s ) = \frac{1}{T} \{ ( {k}_{f} + {c}_{f} s ) θ ( s ) + {h}_{f} {Y}_{f} ( s ) \} \qquad ( Equation 12 )$$

$$\text{?} \text{indicates text missing or illegible when filed}$$

The same applies to the rear wheels 2R. That is, the load displacement amount estimator 14 estimates the rear-wheel side load displacement amount ΔW_{y_r} from the following Equation 12, which is a balance equation of the moment acting around the roll center of the rear wheels 2R, using the model of FIG. 8. Specifically, the rear-wheel side load displacement amount ΔW_{y_r} is estimated (calculated) by solving Equation 13 for the rear-wheel side load displacement amount ΔW_{y_r} and then using Equation 14 obtained by Laplace transformation. In Equations 13 and 14, the symbol T represents the tread (rear tread) and the symbol hᵣ represents the height of the roll center of the rear wheels 2R, both of which are fixed values. In the Equation 13, the symbols Z_{3_0} and Z_{4_0} represent vertical loads on the rear left and right wheels 2RL and 2RR when vehicle is stopped, respectively, the same as those of the front wheel side.

$$\begin{matrix}[ Math . 12 ] & \\ {k}_{f} θ + {c}_{f} \frac{d}{dt} θ + {h}_{\text{?}} {Y}_{\text{?}} + ( {Z}_{1 \_ 0} - Δ {W}_{\text{?}} ) \cdot \frac{T}{2} - ( {Z}_{2 \_ 0} + Δ {W}_{\text{?}} ) \cdot \frac{T}{2} = 0 & ( Equation 13 )\end{matrix}$$

$$Δ {W}_{\text{?}} ( s ) = \frac{1}{T} \{ ( {k}_{f} + {c}_{f} s ) θ ( s ) + {h}_{f} {Y}_{f} ( s ) \} \qquad ( Equation 14 )$$

$$\text{?} \text{indicates text missing or illegible when filed}$$

As described above, the load displacement amount estimator 14 of the present embodiment estimates each of the lateral forces Y_{f} and Yᵣ of the front and rear wheels 2F and 2R. Specifically, the load displacement amount estimator 14 estimates each of the lateral forces Y_{f} and Yᵣ of the front and rear wheels 2F and 2R based on the yaw rate r detected by the yaw rate sensor 21 and the lateral acceleration A_{y} detected by the lateral acceleration sensor 22. Then, the load displacement amount estimator 14 uses 30 the estimated lateral forces Y_{f} and Yᵣ in estimating the above-described load displacement amounts ΔW_{y_f} and ΔW_{y_r}.

The load displacement amount estimator 14 of the present embodiment estimates the respective lateral forces Y_{f} and Yᵣ of the front and rear wheels 2F and 2R by using Equations 16 and 17 obtained by solving the following Equation 15 for the lateral forces Y_{f} and Yᵣ. This estimation is performed at the same calculation cycle as the estimation of the load displacement amounts ΔW_{y_f} and ΔW_{y_r} described above.

$$\begin{matrix}[ Math . 13 ] & \\ \{ \begin{matrix}m {A}_{y} = {Y}_{f} + {Y}_{r} \\ l \dot{r} = {Y}_{f} {L}_{f} - {Y}_{r} {L}_{r} + {M}_{ADD}\end{matrix} & ( Equation 15 )\end{matrix}$$

$${Y}_{f} = \frac{l \dot{r} + m {A}_{y} {L}_{\text{?}} - {M}_{ADD}}{L} \qquad ( Equation 16 )$$

$${Y}_{r} = \frac{- l \dot{r} + m {A}_{y} {L}_{f} + {M}_{ADD}}{L} \qquad ( Equation 17 )$$

$$\text{?} \text{indicates text missing or illegible when filed}$$

In Equations 15 to 17, the symbol L_{f} represents the longitudinal distance between the front axle and the center G of gravity, the symbol Lᵣ represents the longitudinal distance between the rear axle and the center G of gravity, and the symbol L represents the wheelbase (distance between the front and rear axles), all of which are fixed values. Further, the symbol M_{ADD} represents the yaw moment due to difference between braking and driving forces, and in the present embodiment, a demanded control value calculated by a control device different from the control device 10. However, the method of estimating the lateral forces Y_{f} and Yᵣ is not limited to this, and alternatively, the lateral forces Y_{f} and Yᵣ may be estimated at a calculation cycle different from the estimation of the load displacement amounts ΔW_{y_f} and ΔW_{y_r}, or may be estimated in consideration of another parameter in place of or in addition to the yaw moment M_{ADD}.

Further, the load displacement amount estimator 14 of the present embodiment estimates a load displacement amount ΔWₓ (hereinafter referred to as a longitudinal load displacement amount ΔWₓ) between front and rear axles based on the longitudinal acceleration Aₓ detected by the longitudinal acceleration sensor 23, using the following Equation 18. The longitudinal load displacement amount ΔWₓ is used in the estimation of vertical loads Z₁ to Z₄ to be described next. The symbol h_{cg} in the Equation 18 represents the height of the center of gravity.

$$\begin{matrix}[ Math . 14 ] & \\ Δ {W}_{x} = \frac{{mh}_{cg}}{L} {A}_{x} & ( Equation 18 )\end{matrix}$$

The vertical load estimator 15 estimates the vertical loads Z₁ to Z₄ of the respective wheels 2 based on the front-wheel side load displacement amount ΔW_{y_f} and the rear-wheel side load displacement amount ΔW_{y_r} estimated by the load displacement amount estimator 14. Specifically, the vertical load estimator 15 estimates the vertical loads Z₁ to Z₄ of the respective wheels 2 by adding or subtracting the load displacement amount caused by the running condition to or from the vertical loads Z_{1_0} to Z_{4_0} of the wheels 2 when the vehicle is in the stopping state. The vertical load estimator 15 of the present embodiment estimates (calculates) the respective vertical loads Z₁ to Z₄ from the following Equations 19 to 22, using the longitudinal load displacement amount ΔWₓ estimated by load displacement amount estimator 14.

$$\begin{matrix}[ Math . 15 ] & \\ {Z}_{1} = {Z}_{1 \_ 0} - \frac{1}{2} Δ {W}_{x} - Δ {W}_{\text{?}} & ( Equation 19 )\end{matrix}$$

$${Z}_{2} = {Z}_{2 \_ 0} - \frac{1}{2} Δ {W}_{x} + Δ {W}_{\text{?}} \qquad ( Equation 20 )$$

$${Z}_{3} = {Z}_{3 \_ 0} + \frac{1}{2} Δ {W}_{x} - Δ {W}_{\text{?}} \qquad ( Equation 21 )$$

$${Z}_{4} = {Z}_{4 \_ 0} + \frac{1}{2} Δ {W}_{x} + Δ {W}_{\text{?}} \qquad ( Equation 22 )$$

$$\text{?} \text{indicates text missing or illegible when filed}$$

The lateral force estimator 16 estimates the lateral forces Y₁ to Y₄ of the respective wheels 2 based on the four vertical loads Z₁ to Z₄ estimated by the vertical load estimator 15 and the lateral force Y_{f} of the front wheels 2F and the lateral force Yᵣ of the rear wheels 2R. In the present embodiment, since the lateral forces Yᵣ and Yᵣ of the front and rear wheels 2F and 2R are estimated by the load displacement amount estimator 14, the lateral force estimator 16 uses this result of estimation in estimating the lateral forces Y₁ to Y₄ of the respective wheels 2. Specifically, the lateral force estimator 16 estimates (calculates) the lateral forces Y₁ to Y₄ from the following Equations 23 to 26.

$$\begin{matrix}[ Math . 16 ] & \\ {Y}_{1} = \frac{{Z}_{1}}{{Z}_{1} + {Z}_{2}} {Y}_{f} & ( Equation 23 )\end{matrix}$$

$${Y}_{2} = \frac{{Z}_{2}}{{Z}_{1} + {Z}_{2}} {Y}_{f} \qquad ( Equation 24 )$$

$${Y}_{3} = \frac{{Z}_{3}}{{Z}_{3} + {Z}_{4}} {Y}_{r} \qquad ( Equation 25 )$$

$${Y}_{4} = \frac{{Z}_{4}}{{Z}_{3} + {Z}_{4}} {Y}_{r} \qquad ( Equation 26 )$$

### [3. Flow Chart]

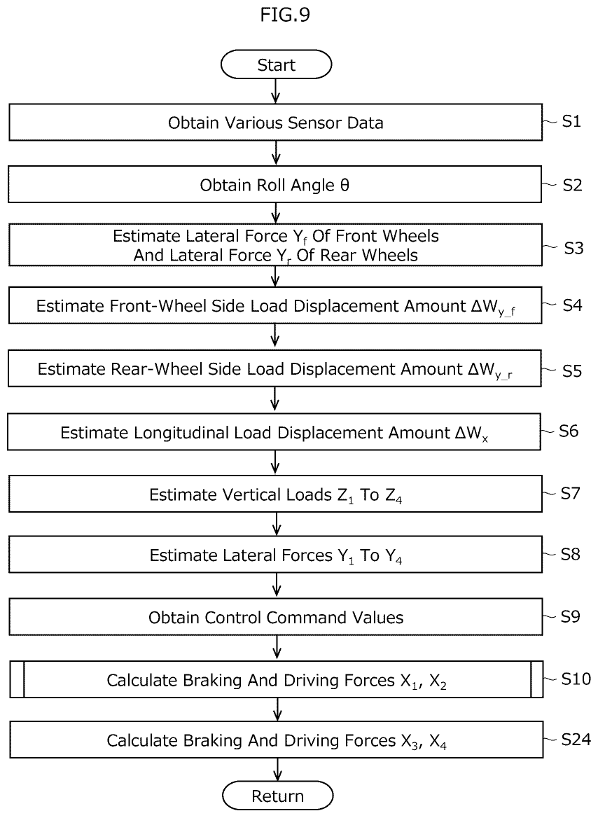

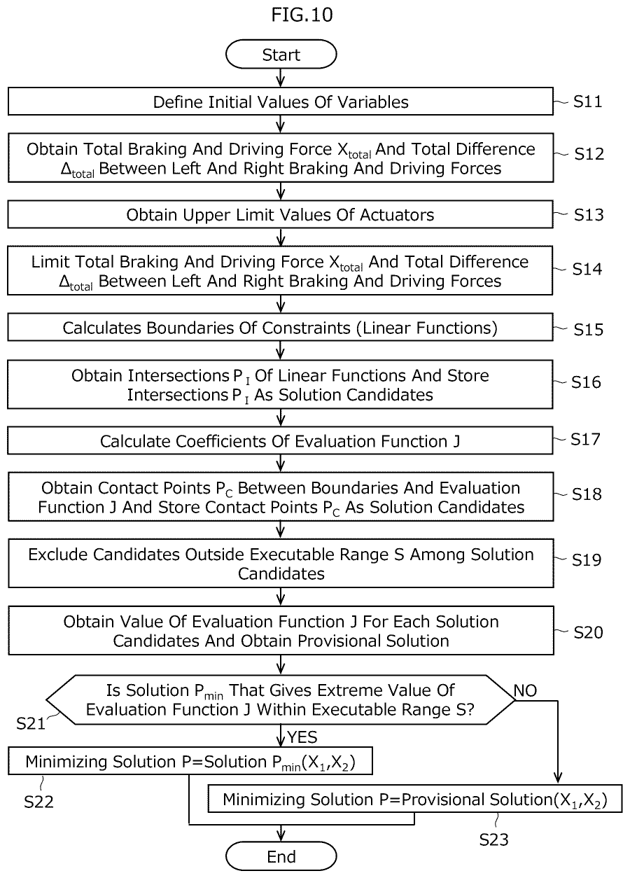

FIG. 9 and FIG. 10 show an example of a flow chart executed by the control device 10 described above. The flow chart of FIG. 10 is a sub-flow chart of Step S10 of the flow chart of FIG. 9. This flow chart is executed at a predetermined calculation cycle, for example, while the main power supply of the vehicle 1 is on or cycle while the vehicle 1 is running. First, the data of the various sensors 21 to 23 are obtained in Step S1. In Step S2, the roll angle θ is obtained by the roll angle obtainer 13. The ensuing Steps S3 to S6 are performed by the load displacement amount estimator 14.

First, in Step S3, each of the lateral forces Y_{f} and Yᵣ of the front and rear wheels 2F and 2R is estimated; in the subsequent Step S4, the front-wheel side load displacement amount ΔW_{y_f} is estimated; in Step S5, the rear-wheel load side displacement amount ΔW_{y_r} is estimated; and in Step S6, the longitudinal load displacement amount ΔWₓ is estimated. Then, in Step S7, the vertical load estimator estimates four vertical loads Z₁ to Z₄, and in Step S8, the lateral force estimator 16 estimates four lateral forces Y₁ to Y₄. These Steps S3 to S8 can also be regarded as 15 processes by the second obtainer 11B.

In Step S9, the demanded torque N and the demanded yaw moment Q serving as the control command values are obtained, and in the subsequent Step S10, an arithmetic operation process on the braking and driving forces X₁ and X₂ of the front wheels 2F by the arithmetic operator 12 (sub-flow chart of FIG. 10) is carried out.

As illustrated in FIG. 10, in Step S11, the initial values of variables (such as a X_{FMAX}, X_{RMAX}, Δ_{FMAX}, Δ_{RMAX}) used in an arithmetic operation are defined. In Step S12, the first obtainer 11 obtains the signal defining the total braking and driving force Xₜₒₜₐₗ and the total difference Δₜₒₜₐₗ between left and right braking and driving forces. In this Step S12, for example, the signal may be obtained (calculated) by substituting the demanded torque N and the demanded yaw moment Q obtained in Step S9 into Equation 1.

In Step S13, the upper limit values of the actuators are obtained. The upper limit values are ones of the front actuator and the rear actuator which give torques to the wheels 2 and are calculated in a different control device from the control device 10. In Step S14, if the values (demanded values) of the total braking and driving force Xₜₒₜₐₗ and the total difference Δₜₒₜₐₗ between left and right braking and driving forces obtained in Step S12 exceed the upper limit values obtained in Step S13, the total braking and driving force Xₜₒₜₐₗ and the total difference Δₜₒₜₐₗ between left and right braking and driving forces are limited by the upper limit values. If the demanded values do not exceed upper limits, the values are not particularly limited in Step S14.

In Step S15, each constraint is expressed (calculated) as a linear function F (X₁, X₂) including at least one of the two variables X₁, X₂ as shown in above Equation 5 and Equation 6′. In the ensuing Step S16, the intersections P_{I} of the linear functions F are calculated and the calculation result (X₁X₂ coordinates of all intersections P_{I}) are stored as solution candidates in the memory device of the control device 10. In Step S17, the coefficients (a₁, a₂, b₁, b₂, C) of the evaluation function J represented by Equation 7 are calculated. In calculating coefficient, the estimated value of the lateral forces Y₁ to Y₄ and the vertical loads Z₁ to Z₄ of the respective wheels 2 obtained by the second obtainer 11B are used.

In Step S18, the contact points P_{c} between the boundaries and the isograms of the evaluation function J are calculated and the calculation result (X₁X₂ coordinates of all contact points P_{c}) are stored as solution candidates in the memory device of the control device 10. In Step S19, among the solution candidates stored in Steps S16 and S18, one or more solution candidates outside the executable range S are excluded, and in Step S20, the value of the evaluation function J is calculated for each of the remaining solution candidates (i.e., candidates within the executable range S), using the coefficients obtained in Step S17 and the solution that obtains the smallest J is determined to be the provisional solution.

In Step S21, whether or not the solution Pₘᵢₙ that gives an apex (extreme value Jₘᵢₙ) of the evaluation function J is present in the executable range S is determined. If the solution Pₘᵢₙ that gives an extreme value is present in the executable range S, the process proceeds to Step S22 in which the solution Pₘᵢₙ that gives an extreme value is obtained as the minimizing solution P. On the other hand, if the solution Pₘᵢₙ that gives an extreme value is not present within the executable range S, the process proceeds to Step S23 in which the provisional solution obtained in Step S20 is obtained as the minimizing solution P.

After the braking and driving forces X₁ and X₂ of the front wheels 2F are determined by the above-described sub-flowchart, the process proceeds to Step S24 in FIG. 9, in which the braking and driving forces X₃ and X₄ of the rear wheels 2R are determined, and this flow chart is returned.

### [4. Actions and Effects]

For the evaluation function J, the above control device 10 is provided with the arithmetic operator 12 serving as an arithmetic device that obtains the minimizing solution P that minimizes the evaluation function J and that satisfies the predetermined constraints without performing iterative calculation. The arithmetic operator 12 includes the first arithmetic operator 12A that sets at least one point (the intersection P_{I} or the contact point P_{c}) on the boundaries obtained from the constrains as one of solution candidates and determines a solution that minimizes the evaluation function J from among the solution candidates as a provisional solution, and the second arithmetic operator 12B that calculates the solution Pₘᵢₙ that gives an extreme value of the evaluation function J and specifies the minimizing solution P based on the solution Pₘᵢₙ that gives the extreme value and the provisional solution. This arithmetic operator 12 (arithmetic device) can reduce the calculation load in solving a constraint minimization problem.

Further, since the above-described control device 10 uses the minimizing solution P calculated as the above is used for the calculation of the braking and driving forces X₁ to X₄ of the respective wheels 2, it is possible to reduce the calculation load in the calculation of the braking and driving forces X₁ to X₄. This contributes to simplification of the control configuration and cost-reduction of the entire vehicle. Further, since the control device 10 described above obtains the braking and driving forces that minimizes the sum of the loads of the respective wheels 2, it is possible to contribute to the improvement in controllability of vehicle motion control.

The above arithmetic operator 12 calculates, as solution candidates, intersections P_{I} between the boundaries represented by the linear functions and contact points P_{c} between the boundaries and isograms of the evaluation function J, and determines the smallest solution among the multiple solution candidates within the executable range S as the provisional solution. That is, a point which minimizes the evaluation function J while satisfying the constraints is any one of a point (i.e., solution Pₘᵢₙ that gives an extreme value) positioned at the apex of the evaluation function J (extreme value Jₘᵢₙ), the intersections P_{I}, and the contact points P_{c}. First of all, an executable range S is set in a three-dimensional space, and a provisional solution is determined from among the solution candidates (intersections P_{I} and contact points P_{c}).

Further, the above-described arithmetic operator 12 specifies the minimizing solution P based on the determined provisional solution and the solution Pₘᵢₙ that gives the extreme value of the evaluation function J. Specifically, if the solution Pₘᵢₙ that gives the extreme value is within the executable range S, the solution Pₘᵢₙ is specified as the minimizing solution P, and if the solution Pₘᵢₙ that gives the extreme value is outside the executable range S, the provisional solution is specified as the minimizing solution P. As the above, since the above arithmetic operator 12 (arithmetic device) can obtain the minimizing solution P by addition, subtraction, multiplication, division and the magnitude comparison, the minimizing solution P can be specified without performing iterative calculation so that the calculation loads can be further reduced. Further, the inclusion of the arithmetic operator 12 in the control device 10 makes it possible to similarly reduce the execution load.

In the control device 10 described above, since the constraints include one that the vehicle 1 satisfies the demanded total braking and driving force of the vehicle 1 and one that the vehicle 1 satisfies the demanded total difference between left and right braking and driving forces, appropriate braking and driving forces X₁ to X₄ can be calculated.

Further, in control device 10 described above, the vertical load estimator 15 serving as a second obtainer 11B that obtains the estimated values of the vertical loads Z₁ to Z₄ of the respective wheels 2 is provided, and the vertical loads Z₁ to Z₄ of the respective wheels 2 can be estimated using a general-purpose sensors (the yaw rate sensor 21 and the lateral acceleration sensor 22) of the standard equipment of the vehicle 1. This means that the vertical loads Z₁ to Z₄ of the respective wheels 2 can be estimated in a relatively simple method without an additional sensor, for example, and the braking and driving forces X₁ to X₄ can be calculated using the estimated vertical loads Z₁ to Z₄. This also contributes to suppression of the calculation load, simplification of the control configuration, and cost-reduction of the entire vehicle.

In the control device 10 described above, the load displacement amounts ΔW_{y_f} and ΔW_{y_r} of the front and rear wheels 2F and 2R are estimated by using the respective lateral forces Y_{f} and Yᵣ of the front and rear wheels 2F and 2R, which are estimated on the basis of the sensor values of the yaw rate r and the lateral acceleration A_{y}. This can enhance the estimating precision of the vertical loads Z₁ to Z₄.

Further, in the control device 10 described above, the longitudinal load displacement amount ΔWₓ is estimated on the basis of the longitudinal acceleration Aₓ detected by the longitudinal acceleration sensor 23, and the vertical loads are estimated by using the longitudinal load displacement amount ΔWₓ, so that the estimated precision can be further enhanced.

The control device 10 described above is provided with the lateral force estimator 16 serving as the second obtainer 11B that obtains estimated values of the lateral forces Y₁ to Y₄ of the respective wheels and also estimating the lateral forces Y₁ to Y₄ of the respective wheels 2 on the basis of the vertical loads Z₁ to Z₄. Then, the braking and driving forces X₁ to X₄ can be calculated by also using the lateral forces Y₁ to Y₄ estimated here. This also contributes to suppression of the calculation load, simplification of the control configuration, and cost-reduction of the entire vehicle. Further, the estimated force in the left-right direction and the estimated force in the vertical direction on each wheel 2 can be applied to various vehicle motion control with ease.

For example, if such estimated force is applied to suppression control of spinning behavior, which is one of the vehicle motion control, the braking and driving force of each wheel 2 can be appropriately set so that the sideslip of the wheels 2 can be effectively suppressed.

### [5. Miscellaneous]

The configuration of the control device 10 described above is an example, and is not limited to the configuration described above. The above vehicle 1 is provided with, as the driving sources, the front motor 3 and the two rear motors 5, and further provided with the differential device 6 that amplifies the torque difference between the two rear motors 5 and then transmits the amplified torque to the respective rear wheels 2R, but the drive sources are not limited thereto. Alternatively, one motor may be mounted as a drive source, an internal combustion engine may be mounted in place of or in addition to the motors, or the differential device 6 may be omitted. The braking devices are not limited to the above-described brake devices 4 and 7. If the vehicle 1 is provided with an ASC (Active Stability Control), the ASC may be activated in accordance with the estimated values estimated by the above control device 10.

In addition, the equations 10, 12, 14, and 16 to 26 used by the above control device 10 in estimation and arithmetic operation are mere examples, and are not limited thereto. For example, in estimating the vertical loads Z₁ to Z₄, the vertical load estimator 15 described above uses the longitudinal load displacement amount ΔWₓ estimated by the load displacement amount estimator 14 is used, but the load movement amount in the longitudinal direction may be omitted or a preset (expected) value may be adopted.

Although the above-described embodiment assumes that the arithmetic operator 12 serving as the arithmetic device is included in the control device 10 mounted on the vehicle 1, the arithmetic device may be mounted on the vehicle 1 separately from the control device 10 or may not be adopted to the vehicle 1. The arithmetic device is applicable to any arithmetic device that solves a constraint minimization problem. The number of constraints and the content of the evaluation function are not particularly limited.

### DESCRIPTION OF REFERENCE SIGNS

1: vehicle
2: wheel
2FL: front left wheel (front wheel, wheel)
2FR: front right wheel (front wheel, wheel)
2RL: rear left wheel (rear wheel, wheel)
2RR: rear right wheel (rear wheel, wheel)
3: front motor (front actuator)
4: front brake device (front actuator)
5: rear motor (rear actuator)
6: differential device (rear actuator)
7: rear brake device (rear actuator)
10: control device
11A: first obtainer
11B: second obtainer
12: arithmetic operator (arithmetic device)
12A: first arithmetic operator
12B: second arithmetic operator
12C: third arithmetic operator
13: roll angle obtainer
14: load displacement amount estimator
15: vertical load estimator (second obtainer)
16: lateral force estimator (second obtainer)
21: yaw rate sensor (yaw rate detecting means)
22: lateral acceleration sensor (lateral acceleration detecting means)
23: longitudinal acceleration sensor (longitudinal acceleration detecting means)
Aₓ: longitudinal acceleration
A_{y}: lateral acceleration
c: vehicle roll damping coefficient
c_{f}: front-wheel roll damping coefficient
cᵣ: rear-wheel roll damping coefficient
G: center of gravity
g: gravitational acceleration
h: roll diameter
h_{f}: height of roll center of front wheels
hᵣ: height of roll center of rear wheels
Iₓ: roll moment of inertia
J: evaluation function
Jₘᵢₙ: extreme value
k: vehicle rolling stiffness
k_{f}: front-wheel rolling stiffness
kᵣ: rear-wheel rolling stiffness
L: wheelbase (distance between front and rear axles)
L_{f}: longitudinal distance between front axle and the center of gravity
Lᵣ: longitudinal distance between rear axle and the center of gravity
m: vehicle weight
M_{ADD}: yaw moment due to difference between braking and driving forces
N: demanded torque
P: minimizing solution
P_{c}: contact point
P_{I}: Intersection
Pₘᵢₙ: solution that gives extreme value
Q: demanded yaw moment
r: yaw rate
S: executable range
T: tread
ΔWₓ: longitudinal load displacement amount (load displacement amount between front and rear axles)
ΔW_{y_f}: front-wheel side load displacement amount (load displacement amount between left and right wheels among the front wheels)
ΔW_{y_r}: rear-wheel side load displacement amount (load displacement amount between left and right wheels among the rear wheels)
X₁: braking and driving force of front left wheel
X₂: braking and driving force of front right wheel
X₃: braking and driving force of rear left wheel
X₄: braking and driving force of rear right wheel
X_{L}: left braking and driving force
X_{R}: right braking and driving force
X_{FMAX}: maximum front braking and driving force
X_{RMAX}: maximum rear braking and driving force
Xₜₒₜₐₗ: total braking and driving force
Y₁: lateral force of front left wheel
Y₂: lateral force of front right wheel
Y₃: lateral force of rear left wheel
Y₄: lateral force of rear right wheel
Y_{f}: lateral force of front wheels
Yᵣ: lateral force of rear wheels
Z₁: vertical load on front left wheel
Z₂: vertical load on front right wheel
Z₃: vertical load on rear left wheel
Z₄: vertical load on rear right wheel
θ: roll angle
Δ_{FMAX}: maximum difference between front braking and driving forces
Δ_{RMAX}: maximum difference between rear braking and driving forces
Δₜₒₜₐₗ: total difference between left and right braking and driving forces

1. An arithmetic device that obtains a minimizing solution of a predetermined evaluation function, the minimizing solution minimizing the evaluation function and satisfying a predetermined constraint, the arithmetic device comprising:
a first arithmetic operator that sets at least one point on a boundary of the evaluation function obtained from the constraint as at least one of solution candidates and determines a solution that minimizes the evaluation function from among the solution candidates as a provisional solution; and
a second arithmetic operator that calculates a solution that gives an extreme value of the evaluation function from a predetermined expression and specifies the minimizing solution based on the solution that gives the extreme value and the provisional solution,
wherein the arithmetic device obtains the minimizing solution without performing iterative calculation.

2. The arithmetic device according to claim 1, wherein
the evaluation function J is expressed in a bivariate function using two variables X₁ and X₂ and forms a graph in a substantially prolate spheroid surface projecting downward in a three-dimensional space, the three-dimensional space having an X₁ axis, an X₂ axis, and a J axis, a plurality of the constraints are provided;
functions that each provide one of the plurality of constrains are expressed in linear functions each containing at least one of the two variables X₁ and X₂,
the first arithmetic operator
calculates, as the solution candidates, an intersection of the linear functions intersecting with each other, and a contact point of a plane and an isogram when the plane serves as the boundary expressed by the linear functions in the three-dimensional space and the isogram of the evaluation function is defined so as to be in contact with the plane, and
determines a set of combinations each containing the two variables X₁ and X₂ satisfying all the plurality of constraints as an executable range S, and
sets one of the solution candidates as the provisional solution, the one of the solution candidates minimizing a value obtained when each of the solution candidates within the executable range S is substituted into the evaluation function,
the second arithmetic operator
specifies, if the solution that gives the extreme value is within the executable range S, the solution that gives the extreme value as the minimizing solution, and
specifies, if the solution that gives the extreme value is outside the executable range S, the provisional solution as the minimizing solution.

3. A vehicle control device comprising:
an arithmetic operator serving as the arithmetic device defined in claim 1- or 2;
a first obtainer that obtains a signal defining a total braking and driving force of a vehicle and a total difference between left and right braking and driving forces; and
a second obtainer that obtains estimated values or measured values of lateral forces and estimated values or measured values of vertical loads of respective wheels of the vehicle, wherein
the arithmetic operator calculates braking and driving forces of the respective wheels using the minimizing solution obtained on the basis of the signal obtained by the first obtainer and the estimated values or the measured values obtained by the second obtainer,
the evaluation function is a function that represents a sum of loads on the respective wheels,
the constraint includes not exceeding a maximum difference between left and right torques and a maximum torque of a front actuator that controls braking and driving forces of front wheels of the vehicle and not exceeding a maximum difference between left and right torques and a maximum torque of a rear actuator that controls braking and driving forces of rear wheels of the vehicle.

4. The vehicle control device according to claim 3, wherein
the constraint further includes satisfying a demanded total braking and driving force of the vehicle and satisfying a demanded total difference between left and right braking and driving forces of the vehicle.

5. The vehicle control device according to claim 4, wherein
the vehicle comprises a yaw rate detecting means that detects a yaw rate of the vehicle and a lateral acceleration detecting means that detects a lateral acceleration of the vehicle,
the vehicle control device further comprises
a roll angle obtainer that obtains a roll angle of the vehicle,
a load displacement amount estimator that estimates a load displacement amount between left and right wheels among the front wheels based on the roll angle obtained, a lateral force of the front wheels, a front-wheel roll damping coefficient of the front wheels, and a front-wheel stiffness of the front wheels, and a load displacement amount between left and right wheels among the rear wheels based on the roll angle obtained, a lateral force of the rear wheels, a rear-wheel roll damping coefficient of the rear wheels, and a rear-wheel stiffness of the rear wheels, and
a vertical load estimator serving as the second obtainer that estimates respective vertical loads on the front wheels and the rear wheels based on the two estimated load displacement amounts, and
the arithmetic operator uses the vertical loads estimated by the vertical load estimator in calculating the braking and driving forces.

6. The vehicle control device according to claim 5, wherein
the load displacement amount estimator uses the lateral force of the front wheels and the lateral force of the rear wheels estimated based on the detected yaw rate and the detected lateral acceleration in estimating the load displacement amounts.

7. The vehicle control device according to claim 5, wherein
the vehicle further comprises a longitudinal acceleration detecting means that detects a longitudinal acceleration of the vehicle,
the load displacement amount estimator estimates, based on the detected longitudinal acceleration, a load displacement amount between a front axle and a rear axle,
the vertical load estimator uses the estimated load displacement amount between the front axle and the rear axle in estimating the vertical loads.

8. The vehicle control device according to claim 6, wherein
the vehicle further comprises a longitudinal acceleration detecting means that detects a longitudinal acceleration of the vehicle,
the load displacement amount estimator estimates, based on the detected longitudinal acceleration, a load displacement amount between a front axle and a rear axle,
the vertical load estimator uses the estimated load displacement amount between the front axle and the rear axle in estimating the vertical loads.

9. The vehicle control device according to claim 5, further comprising
a lateral force estimator serving as the second obtainer that estimates the lateral forces of the respective front wheels and the respective rear wheels based on the four estimated vertical loads, the lateral force of the front wheels, and the lateral force of the rear wheels, wherein
the arithmetic operator uses the lateral forces estimated by the lateral force estimator in calculating the braking and driving forces.

10. The vehicle control device according to claim 7, further comprising
a lateral force estimator serving as the second obtainer that estimates the lateral forces of the respective front wheels and of the respective rear wheels based on the four estimated vertical loads, the lateral force of the front wheels, and the lateral force of the rear wheels, wherein
the arithmetic operator uses the lateral forces estimated by the lateral force estimator in calculating the braking and driving forces.
